(19) United States
(12) Patent Application Publication
(10) Pub. No.: US 2019/0041294 A1
(43) Pub. Date: Feb. 7, 2019

(54) Automotive Testing System, Method and Computer Program Product

(71) Applicant: TASS INTERNATIONAL SOFTWARE AND SERVICES B.V., CC Rijswijk (NL)

(72) Inventors: Martijn TIDEMAN, CC Rijswijk (NL); Martinus Fransiscus Hendricus WANTENAAR, TG Liempde (NL)

(73) Assignee: TASS INTERNATIONAL SOFTWARE AND SERVICES B.V., CC Rijswijk (NL)

(21) Appl. No.: 16/076,741

(22) PCT Filed: Feb. 10, 2017
(86) PCT No.: PCT/NL2017/050083

§ 371 Date: Aug. 9, 2018

(30) Foreign Application Priority Data
Feb. 10, 2016 (EP) 16155078.5

(51) Int. Cl. G01M 17/007

(52) U.S. Cl. CPC G01M 17/007

(57) ABSTRACT

An automotive testing system includes a data processing unit that has a data input port for receiving sensor input data and a data output port for transmitting processed data, a data acquisition unit that forwards sensor input data to the data processing unit that includes a sensor unit that has a sensor system and an electronic system for capturing sensor data, and also includes a synthetic sensor data generator that transmits synthetic sensor data to the electronic system of the sensor unit.

### CROSS-REFERENCE TO RELATED APPLICATIONS

This is a U.S. national stage of application No. PCT/NL2017/050083 filed Feb. 10, 2017. Priority is claimed on EP Application No. 16155078 filed Feb. 10, 2016, the content of which is incorporated herein by reference in its entirety.

### BACKGROUND OF THE INVENTION

### 1. Field of the Invention

The invention relates to an automotive testing system, comprising a data processing unit having a data input port for receiving sensor input data and a data output port for transmitting processed data, and further having a data acquisition unit forwarding sensor input data to said data processing unit that includes a sensor unit having a sensor system and an electronic system for capturing sensor data.

### 2. Description of the Related Art

Automotive testing systems are known for the purpose of testing data acquisition units and data processing units processing sensor input data generated by the data acquisitions units, thereby reducing expensive testing equipment and testing time in realistic traffic circumstances. Data acquisition units can be provided with a camera unit having an optic system and an electronic system for capturing image data.

When testing camera units, e.g., used for dedicated automotive functionality such as variable cruise control, collision avoiding systems or pedestrian detection, an optic image is generated on a display to be captured by the camera unit. Various traffic situations including road traffic and weather circumstances are shown on the display to test the functionality of the camera unit and the data processing unit processing the image data captured by the camera unit.

### SUMMARY OF THE INVENTION

It is an object of the invention to provide a method and an automotive testing system that enables testing even more realistic circumstances.

This and other objects and advantages are achieved in accordance with the invention by an automotive testing system that further comprises a synthetic sensor data generator transmitting synthetic sensor data to the electronic system of the sensor unit.

By using a synthetic sensor data generator instead of a display, the optic system of the camera unit is functionally simulated so that testing data can be represented more realistically to the electronic system of the camera unit. On the one hand, side effects introduced in the optical path of the testing system can be avoided while, on the other hand, real life optic phenomena that are not visible on a display might now be included in the synthetic sensor data mimicking the optical steps performed in the camera unit.

U.S. Pat. No. 5,986,545—Sanada et al. “Vehicle driveability evaluation system” discloses a system for generating driveability signal for a setup in which a real car engine is embedded in a driving simulator. Here, sensor data of the engine is processed with a simulation of external conditions and vehicle dynamics. The output is used to control an artificial load (dynamic dynamometer) for the engine and for synthesizing images and physical feedback, such as acceleration for the driver.

The invention is at least partly based on the insight that a display is inherently limited in its capacity to represent realistic optic circumstances thereby also limiting the performance and/or reliability of the automotive testing system. Further, display features are subjected to bias so that test results of the system are vulnerable to reproducibility issues. In accordance with an embodiment the invention, such disadvantageous effects are circumvented by generating synthetic sensor data that replaces the real image data as well as by transmitting these synthetic sensor data to the electronic system of the sensor unit rather than projecting these to the sensor unit via a display.

It is noted that, within the context of the application, the expression “synthetic sensor data” is to be understood as data that has been generated electronically by simulating data that is normally generated by the respective sensor system.

It is also an object of the invention to provide a non-transitory computer program product. A computer program product may comprise a set of computer executable instructions stored on a data carrier, such as a flash memory, a CD or a DVD. The set of computer executable instructions, which allow a programmable computer to perform the method as defined above, may also be available for downloading from a remote server, for example via the Internet, such as as an app.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

By way of example only, embodiments of the present invention will now be described with reference to the accompanying figures, in which:

FIG. 1 shows a schematic view of an automotive testing system in accordance with the invention;

FIG. 2 shows a flow chart of a first embodiment of a method in accordance with the invention, and

FIG. 3 shows a flow chart of a second embodiment of a method in accordance with the invention.

### DETAILED DESCRIPTION OF THE EXEMPLARY EMBODIMENTS

The figures merely illustrate preferred embodiments according to the invention. In the figures, the same reference numbers refer to equal or corresponding parts.

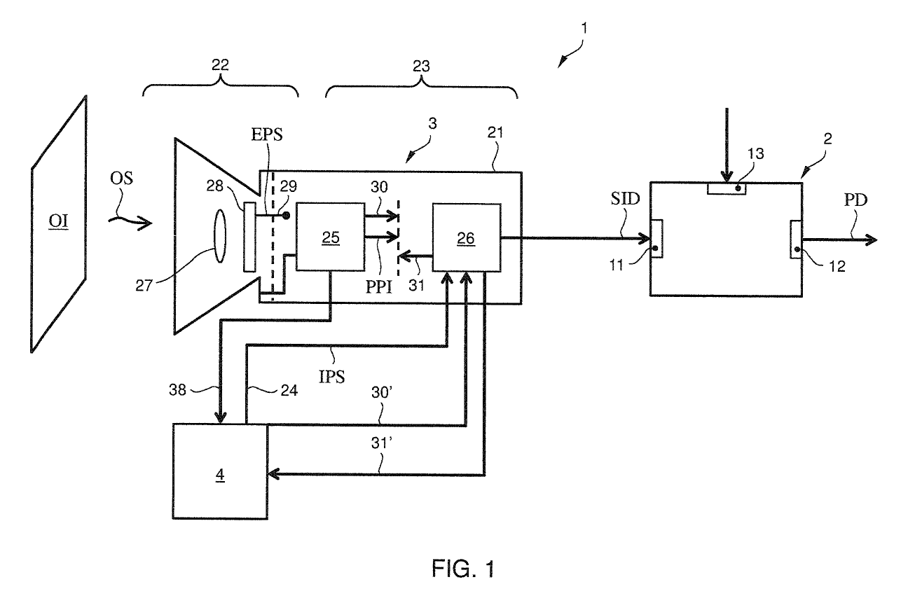

FIG. 1 shows a schematic view of an automotive testing system 1 in accordance with the invention. The system comprises a data processing unit 2, a data acquisition unit 3 and a synthetic sensor data generator 4.

The data processing unit 2 is provided with a data input port 11 for receiving sensor input data and a data output port 12 for transmitting processed data PD, e.g., for the purpose of feeding a control unit for generating control data based on the processed data transmitted by the processing unit 2. In the illustrated embodiment, the processing unit 2 further comprises an additional data input port 13, e.g. for receiving further input data, such as radar data.

The data acquisition unit 3 is arranged for forwarding sensor input data to the data processing unit 2, via the data input port 11 of the data processing unit 2. The data acquisition unit 3 includes a sensor unit 21 having a sensor system 22 and an electronic system 23 for capturing sensor data. In the illustrated embodiment, the sensor unit 21 is implemented as a camera unit, where the sensor system 22 is an optic system and where the sensor data are image data.

Moreover, the synthetic sensor data generator 4 of the automotive testing system 1 is arranged for generating and transmitting synthetic sensor data (also referred to as electronic image pixel signals IPS) to the electronic system 23 of the camera unit 21. In the illustrated embodiment, the image simulating generator 4 is connected to the electronic system 23 of the camera unit 21 via a wired transmission channel 24. In principle, the image pixel signals IPS can be transmitted in another way, such as via a wireless transmission channel.

In the illustrated embodiment, the electronic system 23 of the camera unit 21 includes two modules, e.g., a pre-processing module 25 and a digital signal processing unit DSP 26, arranged in series such that the preprocessing module 25 processes raw image data, converting them into preprocessed image data PPI, while the digital signal processing unit DSP 26 performs further processing on the pre-processed data PPI and then transmits the processed data as sensor input data SID to the data input port 11 of the data processing unit 2. As an example, the pre-processing module 25 might be arranged for removing noise from image data while the digital signal processing unit may be arranged for identifying object information from the image data. Additionally, the pre-processing module 25 transmits status information 30 of the pre-processing module 25 and the optic system 22 towards the digital signal processing unit DSP 26, as metadata.

The optic system 22 of the camera unit 21 typically includes a lens configuration 27 and an image optic sensor 28. Further, the optic system 22 may include other components as well such as a shutter. The image optic sensor 28 can be implemented as a CCD or CMOS sensor converting an optic signals OS received from an optic image OI into electronic pixel signals EPS representing the optic image OI as electronic signals. The image optic sensor 28 may at least partially be integrated with the pre-processing module 25.

In conventional camera units 21, the image optic sensor 28 is connected to the electronic system 23 via a sensor data channel 29 to transmit the electronic pixel signals EPS converted from the optic signals OS towards the electronic system 23 for processing. An optic image OI is then captured by converting optic signals OS into electronic pixel signals EPS and processing said electronic pixel signals EPS by the electronic system 23. In conventional camera units 21, the pre-processing module 25 transmits pre-processed data PPI and status information 30 towards the digital signal processing unit DSP 26. The digital signal processing unit DSP 26 then forwards sensor input data SID to the data input port 11 data processing unit 2 and image enhancements requests and/or commands 31 back to the pre-processing module 25.

During operation of a conventional automotive testing system, an image generator is provided to generate an optic image OI on a display arranged before the camera unit 21. The image generator typically generates a sequence of images forming a video showing realistic traffic situations to simulate common real life traffic circumstances for testing the performance of the camera unit 21 and further systems such as the data processing unit 2 of the automotive testing system 1.

In accordance with an embodiment of the invention, the electronic system 23 of the camera unit 21 receives synthetic sensor data (also referred to as electronic image pixel signals IPS) generated by the synthetic sensor data generator 4 of the automotive testing system 1, thus simulating image data that usually is captured by the camera system via the optic system 22. The electronic pixel signals EPS provided by the image optic sensor 28 no longer forms a basis for the sensor input data SID that is transmitted from the digital signal processor DSP 26 to the data input port 11 of the data processing unit 2. In the illustrated embodiment, the pre-processing module 25 transmits neither pre-processed data PPI nor status information 30 towards the digital signal processing unit DSP 26. The transmission can be stopped, e.g., by physically disconnecting respective transmission channels or by functionally terminating said transmission actions, using software. Further, the transmission of pre-processed data PPI and/or status information 30 towards the digital signal processing unit DSP 26 can also be disabled in another way, e.g., by deactivating the image optic sensor 28 and/or by removing disabling the sensor data channel 29.

An optic image is then captured by generating synthetic image sensor data or electronic image pixel signals IPS simulating in the electronic domain the functionality of the optic system 22 of the camera unit 21 including propagation of the optic signal OS through the lens system 27 and conversion into electronic pixel signals EPS using the image optic sensor 28. Image data captured by the camera unit 21 are now based on the electronic image pixel or data signals transmitted to the electronic system 23 of the camera unit 21.

By bypassing the optic system 22 of the camera unit 21 the optic part of the testing environment is effectively simulated, thus removing artefacts that might be introduced in the optic part during testing but that are not present in real life circumstances. As an example, artefacts might be generated when generating the optic image OI using Red, Green, Blue (RGB) light generating elements. On the other hand, real life optic phenomena that are not visible in the generated optic image OI, such as infrared interaction, might now be included in the image pixel signals IPS mimicking the optical steps performed in the camera unit 21. In addition, the synthetic image data or electronic image pixel data may include RGB sensor data and/or other visible or invisible spectrum data, such as image data associated with an optical wavelength, in a specific visible or invisible spectrum band. When applying an automotive testing system 1 in accordance with disclosed embodiments of the invention, a step of generating the optic image OI has become superfluous.

In a particular embodiment, the image optic sensor 28 may even be removed from the camera unit 21. However, other functionalities of the camera unit 21 remain in operation, e.g., including controlling operations of the lens system and/or shutter operation. In the illustrated embodiment, status information of the pre-processing module 25 and/or optic system 22 e.g., regarding the lens system 27 and other optic components is forwarded to the synthetic sensor data generator 4, as status information 38, so that the image pixel signals IPS may take into account optic propagation behavior of the simulated optic signal OS in the optic system 22 and other processing effects in the pre-processing module 25.

The synthetic sensor data or electronic image pixel signals

IPS might represent pixel data that have already been processed in a preprocessing module 25 of the electronic system 23. The image pixel signals IPS is then transmitted to the digital signal processing unit DSP 26 of the camera unit 21. In the illustrated embodiment, the data transmission channel 24 interconnects the synthetic sensor data generator 4 and the digital signal processing unit DSP 26 so that the image pixel signals IPS is transmitted to the digital signal processing unit DSP 26. The usual electronic interaction between the pre-processing module 25 and the digital signal processing unit DSP 26 is now interrupted. There is no transmission of pre-processed data PPI and status information 30 towards the digital signal processing unit DSP 26 anymore, and no transmission of image enhancements requests and/or commands 31 from the digital signal processing unit DSP 26 back to the pre-processing module 25. Consequently, the digital signal processing unit DSP 26 receives image pixel signals IPS and synthetic status information 30′ of the pre-processing module 25, both from the synthetic sensor data generator 4. Both the image data and status data usually transmitted by the pre-processing module 25 is now simulated by the synthetic sensor data generator 4. In addition, the digital signal processing unit DSP 26 now transmits the image enhancements requests and/or commands 31′ to the synthetic sensor data generator 4, so that the generator 4 may include such information when generating the synthetic image and status data. The image enhancements request and/or commands can be used when generating the synthetic image data.

It should be noted that, alternatively, the image pixel signals IPS might be transmitted to the electronic system 23 in another format, e.g. as raw pixel data that is usually generated by the image optic sensor 28. Consequently, the image pixel signals IPS may be transmitted to the pre-processing module 25 or to another module of the electronic system 23 of the camera unit 21.

It is noted that not only image sensor data can be simulated using synthetic sensor data. In other embodiments in accordance with the invention, the sensor unit is implemented as a unit receiving other sensor signals such as laser signals, infrared signals, radar signals, acoustic signals, ultrasonic signals, pressure signals or electronic signals received in a wired or wireless manner and representing any type of measured physical signals associated with automotive conditions or parameters. The signals may relate to automotive conditions or parameters of a vehicle in which the sensor unit is mounted or automotive conditions or parameters of other vehicles forwarding such signals to the sensor unit. It is further noted that the automotive testing system may include a multiple number of acquisition units, where sensor data is simulated using synthetic sensor data. By providing synthetic sensor data to the electronic system of the respective sensor unit, a process of generating sensor data in the sensor unit can be simulated in the electronic domain in a manner that is more realistic than simulating the parameter to be sensed in the parameter domain, i.e., in the visual, electromagnetic, acoustic, ultra-acoustic or other physical domain.

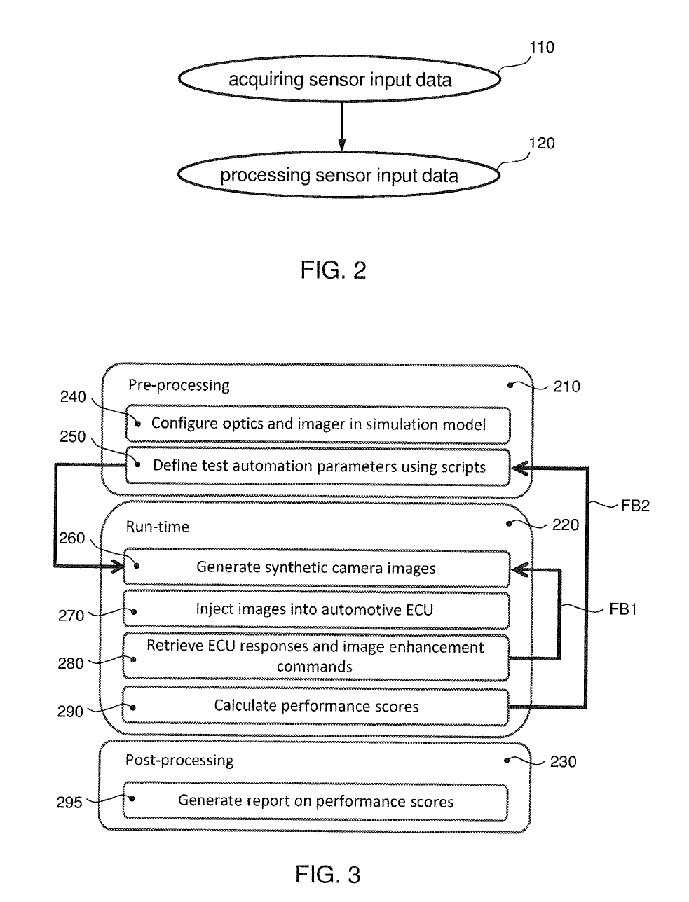

FIG. 2 shows a flow chart of an embodiment of a method in accordance with the invention. The method is used for automotive testing, and comprises a step of acquiring 110 sensor input data, and a step of processing 120 the sensor input data, where the step of acquiring 110 sensor input data includes capturing sensor data using a sensor unit having a sensor system and an electronic system, and where the step of acquiring 110 sensor input data further includes transmitting synthetic sensor data from a synthetic sensor data generator to the electronic system of the sensor unit.

The method of automotive testing can be facilitated using dedicated hardware structures, such as computer servers. Otherwise, the method can also at least partially be performed using a non-transitory computer program product comprising instructions for causing a processor of a computer system to facilitate automotive testing. All (sub)steps can in principle be performed on a single processor. However, it is noted that at least one step can be performed on a separate processor. A processor can be loaded with a specific software module. Dedicated software modules can be provided, e.g., from the Internet.

FIG. 3 shows a flow chart of a second embodiment of a method in accordance with the invention. Here, the method includes three modules, e.g., a pre-processing module 210, a run-time module 220 and a post-processing module 230. The pre-processing module 210 includes a step of configuring 240 optics and imager in a simulation model to create a simulation environment. Further, the pre-processing module 210 includes a step of defining 250 test automation parameters using scrips to define test cases for testing the data acquisition unit. The run-time module 220 includes four steps, viz. a step of generating 260 synthetic camera images using the synthetic sensor data generator, a step of injecting 270 images into an automotive ECU, e.g., by transmitting the synthetic sensor data to the digital signal processing unit DSP being a unit of the electronic system of the sensor unit, a step of retrieving 280 ECU response and image enhancement commands, e.g., by receiving image enhancements requests and/or commands transmitted from the digital signal processing unit DSP from the sensor unit to the synthetic sensor data generator, and a step of calculating 290 performance scores, e.g., by evaluating processed data PD that is output by the data processing unit 2. In addition, the post-processing module 230 includes a step of generating 295 a report on performance scores obtained from the calculated performance scores.

The run-time module 220 includes a first feedback loop FB1 so that a sequence of the generating step 260, the injecting step 270 and the retrieving step 280 is repeatedly performed simulating the test cases defined in the defining step 250 of the pre-processing module 210. Moreover, a second feedback loop FB2 is provided such the defining step 250 is repeated after calculating 290 the performance scores to facilitate additional testing experiments based on test results. It is noted that various alternative embodiments can be implemented, e.g., by including further feedback loops and/or by integrating test results of other test equipment.

It is noted that the electronic system 23 of the sensor unit 21 may include more or less units for processing sensor data. As an example, the sensor unit 21 may be implemented without a digital signal processing unit DSP 26 or with an additional processing unit for processing intermediate sensor data.

These and other embodiments will be apparent for the person skilled in the art and are considered to fall within the scope of the invention as defined in the following claims. For the purpose of clarity and a concise description features are described herein as part of the same or separate embodiments. However, it will be appreciated that the scope of the invention may include embodiments having combinations of all or some of the features described.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-22. (canceled)

23. An automotive testing system, comprising:
a data processing unit having a data input port for receiving sensor input data and a data output port for transmitting processed data;
a data acquisition unit which forwards sensor input data to said data processing unit, the data acquisition unit including a sensor unit having a sensor system and an electronic system for capturing sensor data; and
a synthetic sensor data generator which transmits synthetic sensor data to the electronic system of the sensor unit.

24. The automotive testing system according to claim 23, further comprising:
a data transmission channel interconnecting the synthetic sensor data generator and the electronic system of the sensor unit.

25. The automotive testing system according to claim 1, wherein the sensor input data forwarded by the sensor unit are based on the synthetic sensor data transmitted to the electronic system of the sensor unit.

26. The automotive testing system according to claim 24, wherein the sensor input data forwarded by the sensor unit are based on the synthetic sensor data transmitted to the electronic system of the sensor unit.

27. The automotive testing system according to claim 24, wherein the electronic system of the sensor unit comprises a digital signal processing unit.

28. The automotive testing system according to claim 25, wherein the electronic system of the sensor unit comprises a digital signal processing unit.

29. The automotive testing system according to claim 27, wherein the data transmission channel is arranged to transmit the synthetic sensor data to the digital signal processing unit.

30. The automotive testing system according to claim 27, wherein the testing system is arranged to repeatedly perform a sequence utilizing a first feedback loop, the sequence including:
generating the synthetic sensor data;
transmitting the synthetic sensor data to a digital signal processing unit; and
receiving at least one of image enhancements request and commands from the digital signal processing unit.

31. The automotive testing system according to claim 29, wherein the testing system is arranged to repeatedly perform a sequence utilizing a first feedback loop, the sequence including:
generating the synthetic sensor data;
transmitting the synthetic sensor data to a digital signal processing unit; and
receiving at least one of image enhancements request and commands from the digital signal processing unit.

32. The automotive testing system according to claim 23, wherein the electronic system of the sensor unit comprises a pre-processing unit for pre-processing raw sensor data generated by the sensor system.

33. The automotive testing system according to claim 23, wherein the sensor unit is a camera unit; wherein the sensor system is an optic system; and wherein the sensor data are image data.

34. The automotive testing system according to claim 8, wherein the synthetic sensor data include at least one of (i) Red, Blue, Green (RGB) sensor data and (ii) other visible or invisible spectrum data.

35. The automotive testing system according to claim 23, wherein the synthetic sensor data include simulated infrared signals.

36. The automotive testing system according to claim 23, wherein the synthetic sensor data include at least one of (i) simulated laser signals, (ii) simulated infrared signals, simulated radar signals, (iii) simulated acoustic signals, (iv) simulated ultrasonic signals, (v) simulated pressure signals and (vi) simulated electronic signals received in a wired or wireless way and representing any type of measured physical signals associated with automotive conditions or parameters.

37. The automotive testing system according to claim 23, further comprising:
a control unit for generating control data based on the processed data transmitted by the processing unit.

38. An automotive testing method, comprising:
acquiring sensor input data;
processing the acquired sensor input data;
wherein said acquiring sensor input data includes capturing sensor data via a sensor unit having a sensor system and an electronic system; and
wherein said acquiring sensor input data further includes transmitting synthetic sensor data from a synthetic sensor data generator to the electronic system of the sensor unit.

39. The automotive testing method according to claim 38, further comprising:
generating the synthetic sensor data to be transmitted to the electronic system of the sensor unit.

40. The automotive testing method according to claim 38, wherein said transmitting synthetic sensor data to the electronic system of the sensor unit includes bypassing the sensor system of the sensor unit.

41. The automotive testing method according to claim 39, wherein said transmitting synthetic sensor data to the electronic system of the sensor unit includes bypassing the sensor system of the sensor unit.

42. The automotive testing method according to claim 38, further comprising:
transmitting at least one of (i) sensor enhancements requests and (ii) sensor enhancements commands to the synthetic sensor data generator.

43. The automotive testing method according to claim 39, further comprising:
transmitting at least one of (i) sensor enhancements requests and (ii) sensor enhancements commands to the synthetic sensor data generator.

44. The automotive testing method according to claim 40, further comprising:
transmitting at least one of (i) sensor enhancements requests and (ii) sensor enhancements commands to the synthetic sensor data generator.

45. The automotive testing method according to claim 39, wherein at least one of (i) sensor enhancements requests and (ii) sensor enhancements commands are included for generating synthetic sensor data.

46. The automotive testing method according to claim 38, further comprising:
deactivating a sensor system of the camera unit.

47. An automotive testing method claim 38, further comprising:
performing a sequence repeatedly utilizing a first feedback loop, the sequence including:
generating the synthetic sensor data;
transmitting the synthetic sensor data to a digital signal processing unit; and
receiving at least one of (i) image enhancements request and (ii) commands from the digital signal processing unit.

48. The automotive testing method according to claim 47, further including calculating performance scores after performing the sequence.

49. The automotive testing system according to claim 48, further comprising:
defining test automation parameters to define test cases, after calculating performance scores using a second feedback loop.

50. A non-transitory computer program product for automotive testing, the computer program product comprising computer readable code for causing a processor to:
acquiring sensor input data;
process the acquired sensor input data;
wherein said acquiring sensor input data includes capturing sensor data utilizing a sensor unit having a sensor system and an electronic system; and
wherein said acquiring sensor input data further includes transmitting synthetic sensor data from a synthetic sensor data generator to the electronic system of the sensor unit.
